(19) United States
(12) Patent Application Publication
(10) Pub. No.: US 2006/0081560 A1
(43) Pub. Date: Apr. 20, 2006

(54) Vacuum circuit breaker, vacuum interrupter, electric contact and method of manufacturing the same

(76) Inventors: Shigeru Kikuchi, Hitachi (JP); Masato Kobayashi, Hitachi (JP); Kenji Tsuchiya, Hitachi (JP); Noboru Baba, Hitachiota (JP); Takashi Sato, Mito (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/252,549

(22) Filed: Oct. 19, 2005

(30) Foreign Application Priority Data
Oct. 20, 2004 (JP) 2004-305032

(51) Int. Cl. H01H 33/66

(52) U.S. Cl. 218/123

(57) ABSTRACT

An electrode having an electrical contact for a vacuum interrupter, wherein the electrical contact contains silver, copper and tungsten carbide, and wherein an amount of silver is 24 to 67% by weight, an amount of copper is 5 to 20% by weight and the balance being tungsten carbide, a ratio of copper to silver and copper being less than 28%. The disclosure is concerned with a vacuum interrupter, vacuum circuit breaker and other vacuum switches using the electrical contact.

### CLAIM OF PRIORITY

This application claims priority from Japanese application serial No. 2004-305032, filed on Oct. 20, 2004, the content of which is hereby incorporated by reference into this application.

### FIELD OF THE INVENTION

The present invention relates to a vacuum circuit breaker, a vacuum switch, a vacuum interrupter, an electric contact and a method of manufacturing the same.

### RELATED ART

One of requirements for electrodes disposed in a vacuum interrupter of a vacuum circuit breaker is a small chopping current. If current of the vacuum interrupter used in an inductive circuit is interrupted, abnormal surge voltage is induced, which may lead to insulation breakage of electrical equipments.

In the specification, the electrode is used to mean a combination of an electrical contact and an electrode rod fixed to the contact.

In order to suppress the abnormal surge voltage, the chopping current should be made small. As electrodes that have small chopping current and low surge voltage type Ag—WC series alloy electrodes have been known, which are normally manufactured by an impregnation method, as disclosed in Japanese patent laid-open No. 2002-50253.

However, the low surge voltage type Ag—WC electrodes that contain a large amount of silver are expensive and are high at a production cost because they contain a large amount of tungsten carbide so that they are difficult to be machined. Further, the electrodes manufactured by the impregnation method are poor in anti-welding performance.

### SUMMARY OF THE INVENTION

Accordingly, it is an object of the present invention to provide a low surge voltage type electrode of an inexpensive cost for a vacuum interrupter, a vacuum circuit breaker, which has a sufficient anti-welding performance.

It is another object to provide a circuit breaker and a vacuum interrupter with a low surge voltage type electrode, which is inexpensive and good anti-welding performance.

The present invention provides an electrode having an electrode rod and an electrical contact fixed to the electrode rod for a vacuum interrupter, wherein the electrical contact contains silver, copper and tungsten carbide, and wherein an amount of silver is 24 to 67% by weight, an amount of copper is 5 to 20% by weight and the balance being tungsten carbide, a ratio of copper to silver and copper being less than 28%.

### BRIEF DESCRIPTION OF THE DRAWINGS

FIGS. 1a and 1b show a plan view of a structure and a cross sectional view of an electrode according to an embodiment of the present invention.

FIG. 2 is a cross sectional view of a vacuum interrupter according to an embodiment of the present invention.

FIG. 3 is a diagrammatic view of a vacuum circuit breaker according to an embodiment of the present invention.

FIG. 4 is a diagrammatic view of a load breaking switch to be installed on a road shoulder, according to the present invention.

### DETAILED DESCRIPTION OF THE PREFERRED EMBODIMENTS

The electrode for the vacuum interrupter according to the embodiment of the present invention has an electrical contact that contains as a high electro-conductivity metal silver and copper and as a refractory component tungsten carbide, wherein silver is in an amount of 24 to 67% by weight, copper is in an amount of 5 to 20% by weight, the balance being tungsten carbide, and wherein a weight ratio of copper to the total weight of copper and silver is less than 28% by weight. Employment of silver and copper as the high electrical conductivity metals assures good conduction performance. When tungsten carbide is used as a refractory component, it emits electrons and functions as electric resistance at the time of conduction to evaporate silver by joule heat so that generation of silver vapor is accelerated to make small chopping current value (low surge voltage).

Further, since the amounts of silver, copper and tungsten carbide are contained in amounts mentioned above, the electric contact maintains good conduction performance and sufficiently low surge voltage is assured because the electric contact can be manufactured by a sintering method.

The method of manufacturing the electrode for the vacuum interrupter comprises: compacting a mixture of powders of the high electrical conductive metals such as Ag and Cu and the refractory component such as WC, and sintering the compacted powder mixture at a temperature lower than a eutectic point of silver and copper. Since the eutectic point in case of silver and copper is 780° C., sintering at a temperature higher than the eutectic point may melt the high electrical metals so that the shape of the compacted powder mixture is not kept and heterogeneity in composition of the electrical contact is generated by segregation of the ingredients due to differences in specific gravities of the ingredients.

The electrical contact is provided with curved slit grooves to move generated arc and a shape divided into wings. The slit grooves and wings are formed by filling the powder mixture and compacting it in a metal mold having grooves in a short time. The compacted molding of the wing shape is sintered at a temperature lower than the eutectic point of silver and copper, thereby to produce the electrical contact keeping the compacted shape with the grooves and the wing shape. Accordingly, mechanical machining for forming the grooves is not necessary, thereby to reduce greatly the working time.

In the method of manufacturing the electrical contact according to the present invention, an particle size of the refractory component is preferably 150 μm or less, and an particle size of the high electrical conductive metals is 60 μm or less. When the powders having such the particle sizes are used, the mixture of powders has a good shaping property and a large shrinkage to give a large density, whereby a dense and sound electrical contact with a stable electrical conductivity, anti-welding property and low surge performance is obtained. If flowability of the powder mixture is poor and filling the powder mixture in the metal mold is difficult, a suitable binder is added to the mixture and the mixture is grained by a spray drying method. In the present specification, the particle size means the maximum particle size of metals or compounds used.

In the method of manufacturing the electrical contact for the vacuum interrupter according to the present invention, a pressure for compacting the powder mixture in the metal mold is 100 to 600 MPa. If the pressure is lower than 100 MPa, the specific density of the resulting compacted body is too small and the compacted body is easily crumbled. If the pressure is larger than 600 MPa, the compacted body may be sticked to the metal mold to shorten the life of the mold and lower the productivity.

The vacuum interrupter according to the present invention is provided with a vacuum container, a pair of a fixed electrode and a movable electrode, wherein at least one of the electrodes and the electrical contact that has been described above.

The vacuum circuit breaker according to the present invention comprises a vacuum container, a pair of a fixed electrode and a movable electrode, terminals each being connected to the fixed electrode or the movable electrode, and a switching means for driving the movable electrode, wherein at least one of the fixed electrode and the movable electrode has the electrical contact described above.

The vacuum interrupter according to the present invention can be applied to apparatuses other than the vacuum circuit breakers and vacuum switches.

The electrical contact of the electrodes of embodiments according to the present invention is constituted by silver and copper as high electrical conductivity metal, and tungsten carbide as a refractory component so that the electrical contact has a low surge performance, when the amounts of the ingredients are selected to be the above mentioned values. The electrical contact is obtained by sintering the compacted body at a low production cost. The electrical contact obtained by the sintering method has an adequate bonding strength between the particles of the ingredients (an adequate mechanical weakness or strength) and an excellent anti-welding performance.

In the following, embodiments of the present invention will be explained,

### Embodiment 1

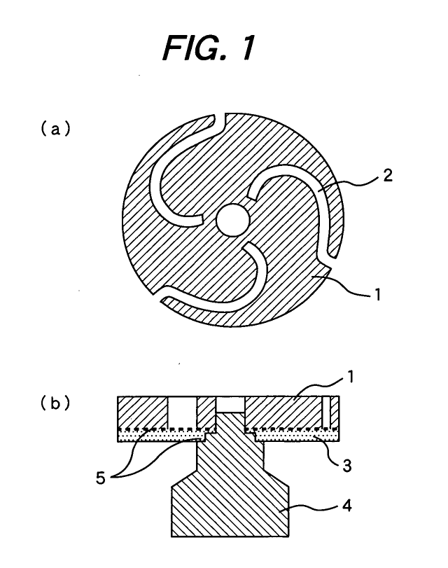

In the first embodiment, an electric contact comprising silver and copper as high electrical conductive metals and tungsten carbide as a refractory component was prepared. FIG. 1a is a plan view of an electrode according to the first embodiment and FIG. 1b is a cross sectional view of the electrode according to the first embodiment. The electrode comprises an electrical contact 1 having spiral grooves 2 for giving driving force to arc, thereby to prevent the arc from stopping, a reinforcing plate 3 made of stainless steel, an electrode rod 4 and a solder 5.

The electrical contact 1 was prepared in the following manner. A particle size of tungsten carbide as a refractory component was about 5 μm, a particle size of silver as a high electrical conductivity was 2 μm and a particle size of copper was 60 μm or less. A composition of the mixed powder was as follows: copper was 5 to 20% by weight, and silver was 24 to 67% by weight so that a weight ratio of copper to the total weight of silver and copper was less than 28% by weight, and the balance was tungsten carbide.

TABLE 1

| | Comp. (wt %) | | | | Inter. | |
|---|---|---|---|---|---|---|
| | High condc. | | Ref. | Manuf. | current | Anti-weld. |
| | Ag | Cu | WC | method | (max.)(A) | (relative) |
| Comp. 1 | 40 | — | 60 | Infil. | 2.1 | 1 |
| Examp. 1 | 28.5 | 5 | 65.5 | Sinter. | 2.7 | 1.4 |
| Examp. 2 | 27 | 10 | 63 | ″ | 2.4 | 1.3 |
| Examp. 3 | 34.8 | 13 | 52.2 | ″ | 2.1 | 1.1 |
| Examp. 4 | 49.2 | 18 | 32.8 | ″ | 2.5 | 1 |
| Examp. 5 | 56 | 20 | 24 | ″ | 2.6 | 0.9 |
| Comp. 2 | 24 | 20 | 56 | ″ | 4.9 | 1 |
| Comp. 3 | 29.4 | 2 | 68.6 | ″ | 4.3 | Broken at |
| | | | | | | separation |

In Table 1, high conduc. means high electrical conductive metals, manuf. method means a manufacturing method, inter. current means a chopping current, anti-weld. means an anti-welding performance, infil. means a melted infiltration method, and sinter. means a sintering method.

Comparative 1 is a standard material, comparative No. 2 has a ratio of copper to silver plus copper larger than 28% by weight, and comparative 3 has a content of copper smaller than 5% by weight.

The powders of silver, copper and tungsten carbide were mixed to make compositions shown in Table 1. Each of the mixed powders was filled in a metal mold having spiral grooves 2, followed by pressurizing molding under a hydraulic pressure of 250 MPa. Relative densities of the resulting compacted, moldings were about 68% with respect to theoretical density. The moldings were sintered in vacuum of 6.7×10⁻³ Pa or lower at 780° C. for 120 minutes to produce electrical contacts Example Nos. 1-5 shown in Table 1. The relative densities of the resulted electrical contacts were 90 to 96% with respect to the theoretical density.

The electrodes were manufactured in the following manner. The electrode rods 4 of oxygen-free copper and the reinforcing plate 3 of stainless steel SUS 340 were machined into a desired shape and the electrical contacts 1, the reinforcing plates having central holes and projections of the electrode rods were assembled with a solder material 5, and the solder material 5 was placed between the electrical contact 1 and the reinforcing plate 3. The assemblies were heated in vacuum of 8.2×10⁻⁴ Pa or less for 8 minutes to produce the electrode shown in FIG. 1. The electrodes were subjected to experiments without post-machining. The electrodes were used for a vacuum interrupter of a rated voltage of 7.2 kV, a rated current of 600 A, and a rated chopping current of 12.5 kA. If the strength of the electrical contact is sufficient to withstand mechanical force during breaking and separation, the reinforcing plate may be omitted.

As described above, the electrodes manufactured in this embodiment of the present invention can be produced in a desired shape in the pressurizing molding, which leads to being used without post-machining after sintering. Therefore, the electrodes are manufactured at low cost.

### Embodiment 2

Using the electrodes manufactured in the first embodiment, a vacuum interrupter provided with the electrode was manufactured. The specification of the vacuum interrupter were: a rated voltage of 7.2 kV, a rated current of 600 A, and a rated chopping current of 12.5 kA.

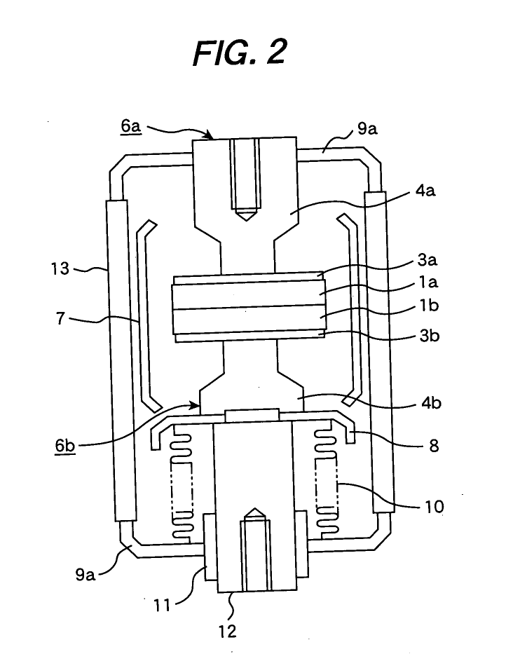

FIG. 2 shows a cross sectional view of a vacuum interrupter according to the embodiment of the present invention. The vacuum interrupter comprises a fixed electrode side electrical contact 1a, a movable electrode side electrical contact 1b, reinforcing plates 3a, 3b, a fixed electrode side electrode rod 4a and a movable electrode side electrode rod 4b, so that the fixed electrode 6a and the movable electrode 6b are constituted.

The movable electrode 6a is bonded by soldering to a movable electrode side holder 12 through a movable electrode side shield 8 for preventing scattering of metal vapor at the time of breaking current. These members are highly vacuum-tight sealed by soldering with a fixed electrode side end plate 9a, a movable electrode side end plate 9b and an insulating cylinder 13. The screw portions of the fixed electrode 6a and movable electrode side holder 12 are connected to the exterior conductors, respectively. There is disposed in the insulating cylinder 13 a shield 7 for preventing scattering metal vapor and a guide 11 for supporting a sliding portion disposed between the movable electrode side end plate 9b and the movable electrode side holder 12. A bellows 10 is disposed between the movable electrode side shield 8 and the movable electrode side end plate 9b thereby to let the movable electrode side holder 12 move up and down to switch on and off the fixed electrode 6a and the movable electrode 6b, keeping the vacuum interrupter in vacuum.

Using the electrodes 6a, 6b having electrical contacts 1a, 1b manufactured in the first embodiment, the vacuum interrupter shown in FIG. 2 was prepared.

### Embodiment 3

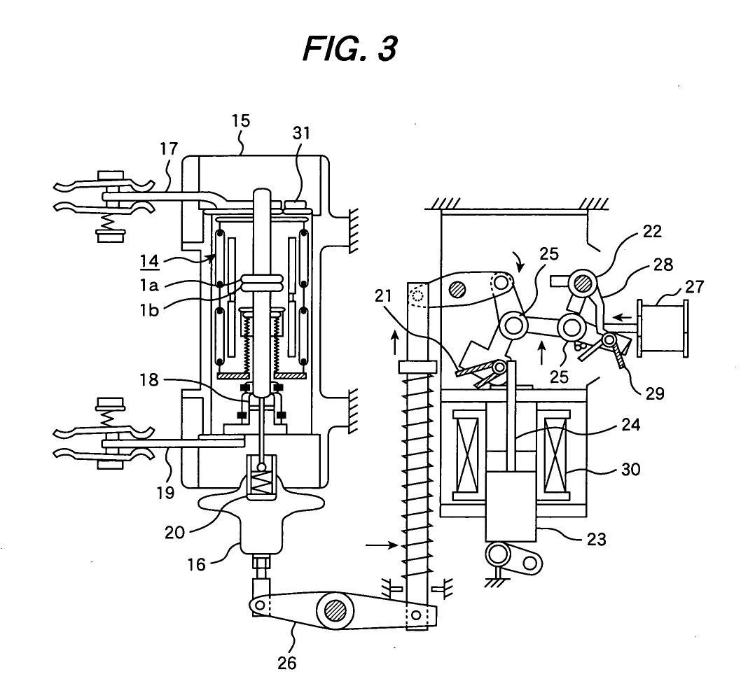

A vacuum circuit breaker provided with the vacuum interrupter shown in FIG. 2 was prepared. FIG. 3 shows a diagrammatic view of the circuit breaker comprising the vacuum interrupter 14 and an operating mechanism.

The vacuum circuit breaker shown in FIG. 3 has the operating mechanism disposed in front of the vacuum interrupter 14. Each of the vacuum interrupters for three phases is disposed in each of epoxy resin cylinders 15. The vacuum interrupter 14 is connected by means of an insulating rod 26 to the operating mechanism.

In case where the circuit breaker is in a closed position, current flows an upper terminal 17, the electrical contact 1, a collector 18 and a lower terminal 19. A contact force between the electrodes is kept by a contact spring 20 disposed to the insulating rod 26. The contact force between the electrodes and electromagneto-motive force is maintained by a supporting lever 21 and a plop 22. When a closing coil 30 is exited, the electrodes in an open state are closed by a plunger 23 that pushes a roller 25 upward by means of a knocking rod 24, then the roller 25 is supported by the supporting lever 21.

In a free state that the circuit breaker is in a tripped condition, a tripping coil 27 is exited so that a tripping lever 28 disconnects the plop 22 to rotate a main lever 26 thereby to separate the electrodes.

In a state that the circuit breaker is in an open state, after the electrodes are separated, the link returns to the original position by a reset spring 29; at the same time, the plop 22 engages. In this state, the closing coil 30 is exited to close the electrodes. The numeral 31 denotes an evacuation tube.

### Embodiment 4

The electrical contacts shown in Table 1, which were manufactured in the first embodiment were subjected to breaking tests of the electrodes to measure chopping current values and evaluation of anti-welding performance. As comparative materials, there are shown comparative No. 2 material which contains copper and silver in a ratio of copper to copper and silver larger than 28%, comparative No. 3 material which contains copper in an amount less than 5% by weight, and a comparative No. 1 material which is a low surge type electrical contact made of 40% Ag-60% WC alloy.

The resulting electrical contact was used to prepare the vacuum interrupter of the rated voltage of 7.2 kV, rated current of 600 A and rated breaking current of 12.5 kV shown in the second embodiment was installed to the vacuum circuit breaker of the third embodiment, which was subjected to breaking performance tests.

The results of the breaking performance tests are shown in Table 1. The chopping current represents the maximum values; the anti-welding performance is represented as 1 of that of the comparative No. 1 electrical contact material. The 40% Ag-60% WC electrical contact material, which is one of conventional low surge type electrical contact materials, has a chopping current of 2.1 A. On the other hand, the electrical contact materials No. 1 to 5 exhibit chopping current values which are the same or slightly larger than that of the 40% Ag-60% WC material No. 1, but these values are acceptable for the practical use.

On the other hand, the electrical contact materials of the embodiments according to the present invention exhibit the anti-welding performance better than that of the comparative No. 1 material. Since the electrical materials according to the embodiments of the present invention are sintered at the temperature lower than the eutectic point of copper and silver, the bonding strength between the particles of the metals is appropriately weak, and the separation force between the welded electrodes is small because the fine particles of tungsten carbide are homogeneously distributed in the materials.

The comparative material No. 2 contains copper in a ratio higher than 28% by weight, which has relatively a high density. Although this material exhibits anti-welding performance slightly poorer than that of the 40% Ag-60% WC material, this performance is acceptable for the practical use.

Copper has a function as a sintering aid for improving sintering characteristics of the material; the higher the amount of the copper content, the higher the density of the material becomes. However, if the ratio of copper to the total amount of copper and silver exceeds 28% by weight in such as comparative material No. 2, which contains a large amount of copper and a small amount of silver, copper and silver make an alloy, which leads to shortage of elemental silver. As a result, vapor of silver is insufficient, thereby to increase the chopping current. Thus, the low surge performance is not expected at all by the material such as comparative No. 2.

If the amount of copper is less than 5% by weight such as the comparative material No. 3, which contains a small amount of copper and an excessive amount of silver, a dense, sound sintered material is not obtained, which does not have low surge property and a insufficient mechanical strength so that the breakage of the electrical contact was observed because of insufficient anti-welding performance.

As is discussed above, the electrodes of the embodiments according to the present invention exhibit sufficiently low surge property from the practical point of view, and exhibit anti-welding performance better than the conventional electrical contact materials.

### Embodiment 5

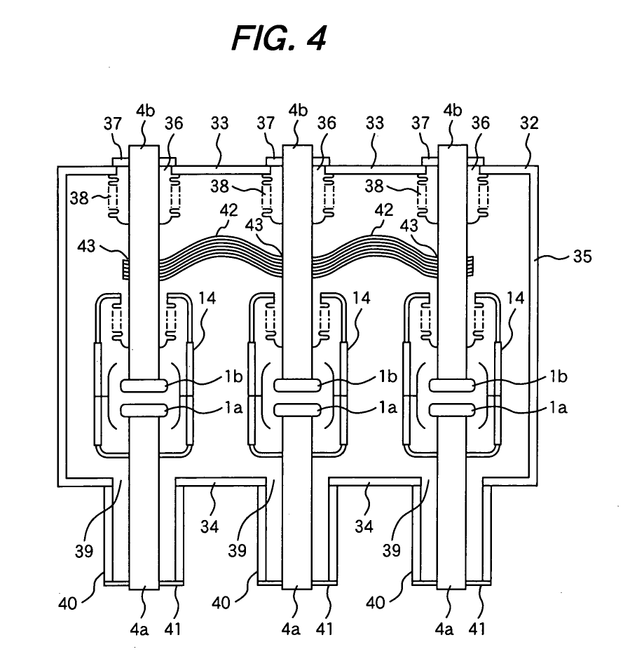

In the fifth embodiment, a vacuum switch apparatus other than the vacuum circuit breaker is described. FIG. 4 is a load breaking switch for a road shoulder installed transformer having a vacuum interrupter 14 prepared in the second embodiment.

The load breaking switch apparatus is provided with plural pairs of vacuum interrupters 14 corresponding to the main circuit switch section in a vacuum-sealed exterior vacuum container 32. The exterior vacuum container 32 comprises an upper plate member 33, a lower plate member 34 and side plate members 35. The peripheries of the plate members are hermetically welded. The exterior vacuum container 32 is installed together with a main body of the apparatus.

The upper plate member 33 is provided with upper through-holes 36, the peripheries of which are provided with ring-shaped insulating upper bases 37 to seal the through-holes 36. Columnar movable electrode rods 4b are reciprocately (up-and-down movement) inserted into the circular spaces formed in the central parts of the upper bases. That is, the upper through-holes 36 are vacuum tightly sealed by the upper bases 37 and the movable electrode rods 4b.

The axial ends (upper sides) of the movable electrode rods 4b are connected to electro-magnetic operators (not shown) disposed at the exterior of the exterior vacuum container 32. The upper plate member 33 is provided with outer bellows 38, which are reciprocately (up-and down movement) fixed to the peripheries of the upper through-holes 36. Each of the outer bellows 38 is fixed to the lower side of the upper plate member 33 at its axial direction, and is fixed to the circumferential face of each of the movable electrode rods 4b at its other end. That is, in order to vacuum-tightly seal the exterior vacuum container 32, the outer bellows 38 are disposed at the peripheries of the upper through-holes 36 and along the axes of the movable electrode rods 4b. The upper plate member 33 is provided with an evacuation tube (not shown) through which the exterior vacuum container 32 is evacuated.

On the other hand, the lower plate member 34 is provided with lower through-holes 39; insulating bushings 40 are fixed to the peripheries of the lower through-holes 39 thereby to cover the lower through-holes. Ring-shaped lower bases 41 are disposed to the bottom parts of the insulating bushings 40. Columnar fixed electrode rods 4a are inserted into the central circular space portions of the lower bases 41. That is, the lower through-holes 39 formed in the lower plate member 34 are vacuum-tightly sealed by the insulating bushings 40, the lower bases 41 and fixed electrode rods 4a. Each of the fixed electrode rods 4a is connected at one end (lower side) in the axial direction to each of cables (transmission cables) disposed outside of the exterior vacuum container 32.

The vacuum interrupters 14 corresponding to the main circuit switch of the load-breaking switch are disposed in the exterior vacuum container 32. Each of the movable electrode rods 4b are connected to each other by means of flexible conductors 42 having two curved portions. The flexible conductors 42 are prepared by laminating copper plates and stainless plates alternately, the copper plates and the stainless steel plates having two curved portions in the axial direction of the electrode rods 4a, 4b.

The flexible conductors 42 have through-holes 43 through which the movable electrode rods 4b are inserted into the through-holes 43.

As having been discussed, the vacuum interrupter according to the second embodiment can be applied to the load breaking switch for the road-shoulder installed switch apparatus. Further, the vacuum interrupter of the present invention can be employed for other vacuum switching apparatuses.

What is claimed is:

1. An electrode having an electrode rod and an electrical contact fixed to the electrode rod for a vacuum interrupter, wherein the electrical contact contains silver, copper and tungsten carbide, and wherein an amount of silver is 24 to 67% by weight, an amount of copper is 5 to 20% by weight and the balance being tungsten carbide, a ratio of copper to silver and copper being less than 28%.

2. The electrode for a vacuum interrupter according to claim 1, wherein the electrical contact is a sintered body of powders of silver, copper and tungsten carbide.

3. A method of manufacturing an electrical contact for a vacuum interrupter, which comprises: mixing silver powder, copper powder and tungsten carbide powder; pressurizing molding the mixed powder into a desired shape; and sintering the molded mixture at a temperature lower than a eutectic point of silver and copper.

4. The method of manufacturing an electric contact for a vacuum interrupter according to claim 3, wherein a particle size of the tungsten carbide powder is 150 μm or less and a particle size of copper powder and silver powder is 60 μm or less.

5. The method of manufacturing an electric contact for a vacuum interrupter according to claim 3, wherein the pressurizing molding is carried out in a metal mold having slit grooves to form wing forms.

6. The method of manufacturing an electric contact for a vacuum interrupter according to claim 3, wherein the pressure for the pressurizing molding is 100-600 Mpa.

7. A vacuum interrupter comprising a vacuum container and a pair of a fixed electrode having an electrical contact and a movable electrode having an electrical contact, the electrodes being disposed in the vacuum container, wherein at least one of the electrical contacts is the electrical contact defined in claim 1.

8. A vacuum circuit breaker comprising a vacuum container, a pair of a fixed electrode having an electrical contact and a movable electrode having an electrical contact, the electrodes being disposed in the vacuum container, outer terminals disposed outside of the vacuum container, the terminals being electrically connected to the respective fixed electrode and the movable electrode, and one or more operating mechanism for driving the movable electrode, wherein at least one of the electrical contacts of the vacuum interrupter is the electrical contact defined in claim 1.
